(19) United States
(12) Patent Application Publication
(10) Pub. No.: US 2022/0026301 A1
(43) Pub. Date: Jan. 27, 2022

(54) TANK DEVICE FOR STORING COMPRESSED FLUIDS, COMPRISING A SENSOR MODULE ARRANGEMENT

(71) Applicant: Robert Bosch GmbH, Stuttgart (DE)

(72) Inventors: Alexander Lux, Tambach-Dietharz (DE); Sandra Kruse, Stuttgart (DE)

(21) Appl. No.: 17/297,618

(22) PCT Filed: Nov. 13, 2019
(86) PCT No.: PCT/EP2019/081196

§ 371 Date: May 27, 2021

(51) Int. Cl. G01L 19/14; G01L 19/06; B60L 50/72; F17C 13/02; H01M 8/04089; H01M 8/04082; H01M 8/0438

(52) U.S. Cl. CPC G01L 19/147; G01L 19/0636; B60L 50/72; F17C 13/025; H01M 8/04089; H01M 8/04201; H01M 2250/20; F17C 2250/043; F17C 2205/0326; F17C 2270/0184; F17C 2221/012; F17C 2223/0123; H01M 8/04425

(57) ABSTRACT

The invention relates to a tank device (24) for storing compressed fluids, in particular hydrogen, comprising at least one tank container (26) and a sensor module arrangement (100), wherein the sensor module arrangement (100) has a high-pressure sensor module (28). The sensor module arrangement (100) further comprises a low pressure sensor module (1), which low pressure sensor module (1) cooperates with a pressure regulating valve (44).

### BACKGROUND OF THE INVENTION

The invention relates to a tank device for the storage of compressed fluids with a sensor module arrangement, in particular for a fuel cell tank for storing hydrogen, for example for use in vehicles with fuel cell drives.

The unpublished DE 10 2018 209 057 A1 describes a tank device for the storage of compressed fluids, wherein the tank device contains tanks with a number of valves, which ensure proper and safe functioning of an entire system, for example a fuel cell system.

In addition to the valves, a pressure sensor module arrangement is also in use to monitor the level of the tank device with hydrogen, for example. High pressure sensors are typically used here, which are essential for pressure measurement with a full tank container, at a pressure of 350 bar or 700 bar, for example.

In the course of the emptying of the tank device and with decreasing pressure in the tank device, the high pressure sensors have high inaccuracy in the indication of the pressure, so that taking into account all the safety factors the tank container can only be emptied to approx. 20 bar. This reduces the range of a vehicle with such a tank container device.

### SUMMARY OF THE INVENTION

The device according to the invention, on the other hand, has the advantage that the efficiency of the tank device is increased by using a pressure sensor module arrangement with a higher accuracy in the low pressure range.

For this purpose, the tank device according to the invention for the storage of compressed fluids, in particular hydrogen, has at least one tank container and a sensor module arrangement. The sensor module arrangement also has a high pressure sensor module. In addition, the sensor module arrangement contains a low pressure sensor module, which interacts with a pressure control valve.

By using a high pressure sensor module and a low pressure sensor module, the pressure can be precisely determined both in a high range and in a low range, so that an accurate level reading of the tank container is possible. As a result, high efficiency and a long range of the vehicle are achieved. Furthermore, due to the use of a pressure control valve the low pressure sensor module is protected against excessive pressures, so that mechanical overloads, which can lead to damage to the low pressure sensor module, are minimized.

In a first advantageous development, it is provided that the low pressure sensor module or the high pressure sensor module has a sensor housing, in which sensor housing a sensor chip is arranged, which sensor chip can be connected via wire connections to a leadframe. Advantageously, the sensor housing is made of a plastic and advantageously the sensor chip contains a pressure-sensitive, micromechanical module. As a result, the pressure conditions in the tank container can be determined precisely more easily and more effectively.

In a further embodiment of the invention it is advantageously provided that the sensor module arrangement contains a mechanical connection element and an electrical connection element, wherein the mechanical connection element is fixedly connected to the low pressure sensor module or the high pressure sensor module and the electrical connection element has plug elements, which are connected by electrical contacting to the low pressure sensor module or the high pressure sensor module. Advantageously, the mechanical connection element has a recess in which recess a gas-permeable protective element for the low pressure sensor module or the high pressure sensor module is arranged.

During the operation of the tank device, solid particles can be whirled up from the tank container and can thus pass close to the low pressure sensor module or the high pressure sensor module. If these solid particles reach, for example, the sensor chip or the wire connections between the sensor chip and the leadframe or the electrical contacting, mechanical damage may occur, which may lead to a functional impairment of the low pressure sensor module or of the high pressure sensor module.

In an advantageous development, the gas-permeable protective element contains a choke element.

In an advantageous development, the gas-permeable protective element contains a sieve element.

Thus, the hydrogen can flow in a simple way by the use of gap openings towards the low pressure sensor module or the high pressure sensor module, while the solid particles remain behind.

In an advantageous development, the gas-permeable protective element comprises a membrane element. In this case, the membrane element is designed so that the hydrogen can flow through, while the solid particles are held back by the membrane element.

The tank device described is preferably suitable in a fuel cell arrangement for storing hydrogen for the operation of a fuel cell.

In advantageous uses, the tank device can be used to store compressed fluids in vehicles with a drive with gaseous fuels.

### BRIEF DESCRIPTION OF THE DRAWINGS

In the drawing, exemplary embodiments of a tank device for the storage of compressed fluids with a sensor module arrangement are shown.

FIG. 1 shows an embodiment of a low pressure sensor module/high pressure sensor module according to the invention in a longitudinal section,

FIG. 2a shows a sensor module arrangement in a longitudinal section with a low pressure sensor module/high pressure sensor module according to the invention of the exemplary embodiment according to FIG. 1,

FIG. 2b shows the sensor module arrangement from FIG. 2a in a side view,

FIG. 3a shows another exemplary embodiment of a sensor module arrangement according to the invention with a low pressure sensor module/high pressure sensor module and a gas-permeable protective element in a longitudinal section,

FIG. 3b shows another exemplary embodiment of a sensor module arrangement according to the invention with a low pressure sensor module/high pressure sensor module and a gas-permeable protective element in a longitudinal section,

FIG. 3c shows another exemplary embodiment of a sensor module arrangement according to the invention with a low pressure sensor module/high pressure sensor module and a gas-permeable protective element in a longitudinal section,

FIG. 4 shows a vehicle with a tank device according to the invention containing a sensor module arrangement in a schematic view.

### DETAILED DESCRIPTION

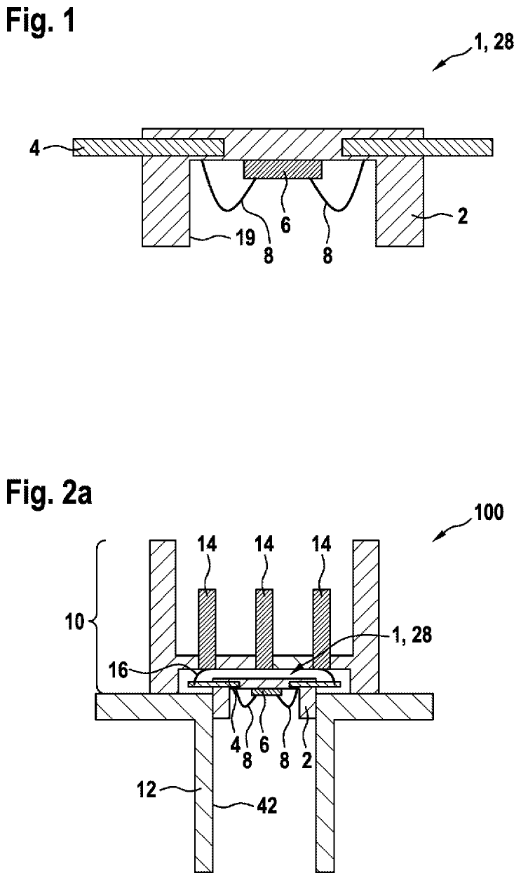

FIG. 1 shows an exemplary embodiment of a low pressure sensor module 1 or a high-pressure sensor module 28 in a longitudinal section. The low pressure sensor module 1 or the high pressure sensor module 28 has a sensor-housing 2, in which a leadframe 4 is fixedly integrated.

The leadframe 4 is a metallic cable carrier, typically in the form of a frame or a comb. The individual contacts, which are called leads, are connected to each other, wherein the frame can be connected to the other frames, if present.

The sensor housing 2 also has a recess 19, in which a sensor chip 6 is arranged. The sensor chip 6 is directly connected to the sensor housing 2 and arranged on the leadframe 4, so that the sensor chip 6 can be connected to the leadframe 4 via wire connections 8, for example bonding wires. Furthermore, the sensor chip 6 is made of a pressure-sensitive, micromechanical module.

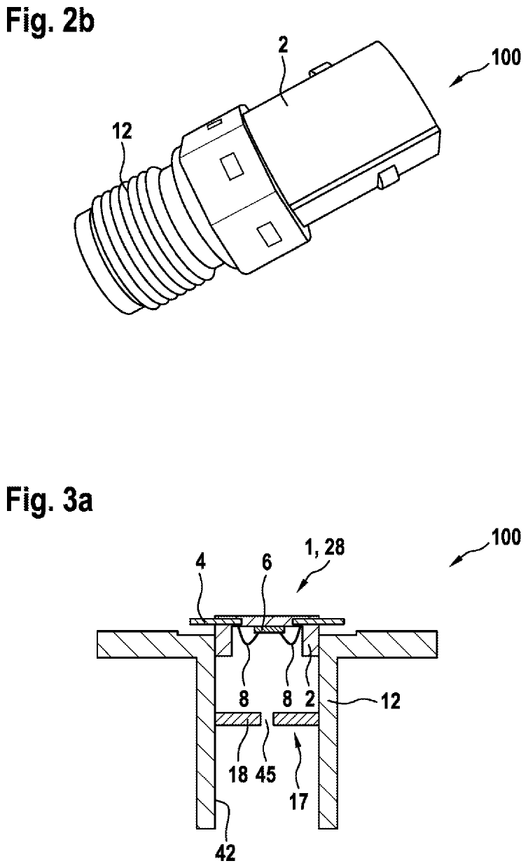

FIG. 2a shows the exemplary embodiment from FIG. 1 in a sensor module arrangement 100. The sensor module arrangement 100 contains the low pressure sensor module 1 or the high pressure sensor module 28, an electrical connection element 10 and a mechanical connection element 12. The low pressure sensor module 1 or the high pressure sensor module 28 is connected to the mechanical connecting element 12 and partially arranged in a recess 42 of the mechanical connecting element 12. In this case, the low pressure sensor module 1 or the high pressure sensor module 28 is fixedly connected to the mechanical connection element 12.

The electrical connection element 10 is also fixedly connected to the mechanical connecting element 12, wherein the low pressure sensor module 1 or the high pressure sensor module 28 is arranged between the electrical connection element 10 and the mechanical connection element 12.

The electrical connection element 10 has plug elements 14, which are connected via electrical contacting 16 to the leadframe 4 of the low pressure sensor module 1 or of the high pressure sensor module 28. Thus, for example, an electrical connection can be established to a control unit.

FIG. 2b also shows a side view of the sensor module arrangement 100 from FIG. 2a, wherein the sensor housing 2 is made of a plastic here.

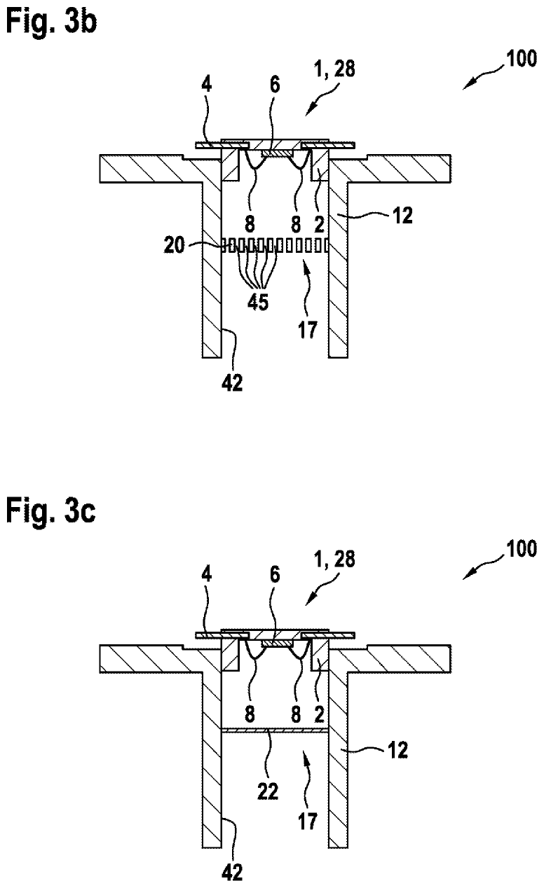

FIG. 3a, FIG. 3b, FIG. 3c show a section of the sensor module arrangement 100 from FIG. 2a in the area of the mechanical connecting element 12 in a longitudinal section. In the recess 42 of the mechanical connection element 12 a gas-permeable protective element 17 is arranged here for the protection of the low pressure sensor module 1 or of the high pressure sensor module 28 against solid particles during the operation of the sensor module arrangement 100.

FIG. 3a shows the gas-permeable protective element 17 in the form of a choke element 18 with a gap opening 45.

FIG. 3b shows the gas-permeable protective element 17 in the form of a sieve element 20 with a number of gap openings 45.

FIG. 3c shows the gas-permeable protective element 17 in the form of a membrane element 22.

When using the sensor module arrangement 100 in a tank device 24 for compressed fluids, for example hydrogen, by using such a gas-permeable protective element 17 proper functioning of the sensor module arrangement 100 can be ensured, since solid particles, which can pass into the hydrogen through the refueling, cannot penetrate as far as the sensor chip 6 and thus cannot cause mechanical damage to the low pressure sensor module 1 or the high pressure sensor module 28.

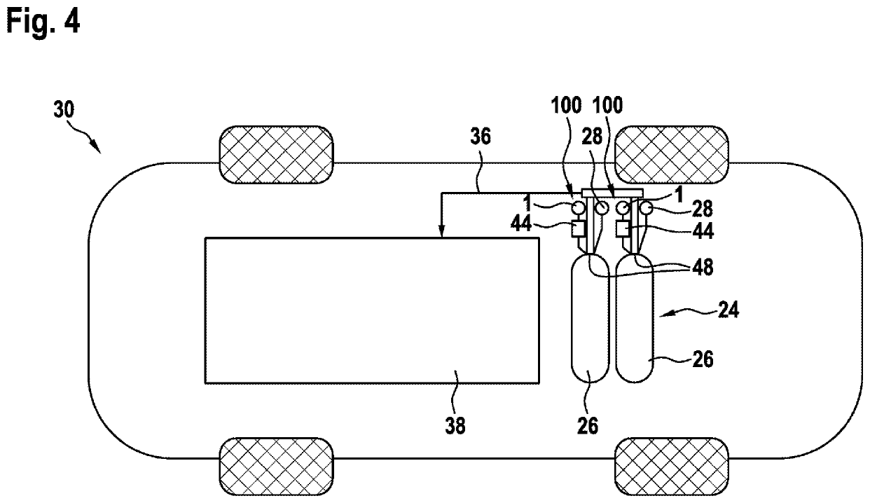

FIG. 4 shows by way of example a vehicle 30 with the tank device 24 for storing compressed fluids with a fuel cell drive in a schematic view. A fuel cell assembly 38 with a tank device 24 and a sensor module arrangement 100 according to the invention is integrated in the chassis of the vehicle 30. The tank device 24 supplies the fuel cell assembly 38 with hydrogen via a feeding system 36 and is arranged here in the rear of the vehicle. Alternatively, the tank device 24 may also be arranged at another position in the vehicle 30.

The tank device 24 has two tank containers 26 here, in which the hydrogen can be stored. In a neck area 48 of each tank container 26 a sensor module arrangement 100 is arranged here, which contains a high pressure sensor module 28, and a pressure control valve 44 with a sensor module arrangement 100, which contains a low pressure sensor module 1. In this case, the number of tank containers 26 in the tank device 24 can vary, wherein each tank container 26 has a sensor module arrangement 100, which contains a high pressure sensor module 28, and a pressure control valve 44 with a sensor module arrangement 100, which contains a low pressure sensor module 1. In an alternative version, the entire tank device 24 has a respective sensor module arrangement 100, which contains a high pressure sensor module 28, and a pressure control valve 44 with a sensor module arrangement 100, which contains a low pressure sensor module 1.

Thus, the pressure within each tank container 26 can be determined and the filling level can be determined precisely. Furthermore, the use of a protective gel for the sensor chip 6 and the electrical environment are dispensed with, since the sensor module arrangement 100 is used here in a liquid-free medium, i.e. high-purity gaseous hydrogen, and the water content is too low for condensation at the operating temperatures. Therefore, the formation of short circuits or water-induced corrosion is minimized.

1. A tank device (24) for storing compressed fluids, the tank device comprising at least one tank container (26) and a sensor module arrangement (100), wherein the sensor module arrangement (100) contains a high pressure sensor module (28), characterized in that the sensor module arrangement (100) contains a low pressure sensor module (1), wherein the low pressure sensor module (1) interacts with a pressure control valve (44).

2. The tank device (24) as claimed in claim 1, characterized in that the low pressure sensor module (1) or the high pressure sensor module (28) has a sensor housing (2), in which a sensor chip (6) is arranged, wherein the sensor chip (6) is configured to be connected to a leadframe (4) via wire connections (8).

3. The tank device (24) as claimed in claim 2, characterized in that the sensor housing (2) is made of a plastic.

4. The tank device (24) as claimed in claim 2, characterized in that the sensor chip (6) comprises a pressure-sensitive, micromechanical module.

5. The tank device (24) as claimed in claim 1, characterized in that the sensor module arrangement (100) comprises a mechanical connection element (12) and an electrical connection element (10), wherein the mechanical connection element (12) is fixedly connected to the low pressure sensor module (1) or the high voltage sensor module (28) and the electrical connection element (10) comprises plug elements (14) which are connected to the low pressure sensor module (1) or the high pressure sensor module (28) via electrical contacting (16).

6. The tank device (24) as claimed in claim 5, characterized in that the mechanical connecting element (12) has a recess (42), in which a gas-permeable protective element (17) for the low pressure sensor module (1) or the high pressure sensor module (28) is arranged.

7. The tank device (24) as claimed in claim 6, characterized in that the gas-permeable protective element (17) contains a choke element (18).

8. The tank device (24) as claimed in claim 6, characterized in that the gas-permeable protective element (17) contains a sieve element (20).

9. The tank device (24) as claimed in claim 6, characterized in that the gas-permeable protective element (17) contains a membrane element (22).

10. A fuel cell arrangement (38) with a tank device (24) as claimed in claim 1.

11. A vehicle with a tank device (24) for storing compressed fluids as claimed in claim 1.

12. The tank device (24) as claimed in claim 1, wherein the tank device is configured to store compressed gases.

13. The tank device (24) as claimed in claim 1, wherein the tank device is configured to store compressed hydrogen.

14. The tank device (24) as claimed in claim 3 characterized in that the sensor chip (6) comprises a pressure-sensitive, micromechanical module.

15. The tank device (24) as claimed in claim 14, characterized in that the sensor module arrangement (100) comprises a mechanical connection element (12) and an electrical connection element (10), wherein the mechanical connection element (12) is fixedly connected to the low pressure sensor module (1) or the high voltage sensor module (28) and the electrical connection element (10) comprises plug elements (14) which are connected to the low pressure sensor module (1) or the high pressure sensor module (28) via electrical contacting (16).

16. The tank device (24) as claimed in claim 15, characterized in that the mechanical connecting element (12) has a recess (42), in which a gas-permeable protective element (17) for the low pressure sensor module (1) or the high pressure sensor module (28) is arranged.

17. The tank device (24) as claimed in claim 16, characterized in that the gas-permeable protective element (17) contains a choke element (18).

18. The tank device (24) as claimed in claim 16, characterized in that the gas-permeable protective element (17) contains a sieve element (20).

19. The tank device (24) as claimed in claim 16, characterized in that the gas-permeable protective element (17) contains a membrane element (22).
